(19) United States
(12) Patent Application Publication
(10) Pub. No.: US 2008/0295607 A1
(43) Pub. Date: Dec. 4, 2008

(54) Method of Measuring the Ratio of Gas Volume Flow Rate to the Volume Flow Rate of a Multiphase Hydrocarbon Mixture

(76) Inventors: David Di Maggio, Pin Balma (FR); Pierre-Yves David, Paris (FR)

Correspondence Address: WENDEROTH, LIND & PONACK, L.L.P., 2033 K STREET N. W., SUITE 800, WASHINGTON, DC, 20006-1021, US

(21) Appl. No.: 11/658,919

(22) PCT Filed: Jul. 20, 2005
(86) PCT No.: PCT/FR2005/001867

§ 371 Date: Jan. 30, 2007

(30) Foreign Application Priority Data
Jul. 30, 2004 (FR) 0408472

(51) Int. Cl. G01F 1/74

(52) U.S. Cl. 73/861.04

(57) ABSTRACT

The invention relates to a method of measuring the ratio of gas volume flow rate to the volume flow rate of a multiphase hydrocarbon mixture. The inventive method comprises the following steps consisting in: sampling (A) the gas and liquid in the pipeline and measuring the ratio (α_{g}) of the section occupied by the gas in the flow of the mixture; analysing (B) the composition of the gas and liquid samples in order to determine the mass or mole fraction of the carbon compounds, composition parameters [Xᵢ] [Yᵢ]; using [Xᵢ] [Yᵢ] to determine the intensive properties of each phase (?_{liquid}, ?_{gas}) with the aid of a thermodynamic equilibrium simulation; calculating (D) the measured density (?ₘₘ) of the mixture; using an adaptive process to calculate (E) the calculated density (?ₑ) of the mixture by comparing ?_{c} and ?ₘₘ, the mixture being analytically reconstructed when said density values are equal; and calculating (F) the ratio (GVF) of the gas volume flow rate to the volume flow rate of the mixture. The invention can be used for the management and exploitation of hydrocarbon pipelines downstream of the wellhead.

The management and regulation of oil production plant require knowledge of numerous parameters for the transportation by pipelines of multiphase hydrocarbon mixtures flowing therein, these multiphase mixtures forming, for operators, a production fluid to which the aforementioned regulation and management parameters have to be applied.

In particular, streamlined regulation and management of these production fluids, and of the production eventually achieved, entails sufficiently precise knowledge of specific parameters of these multiphase mixtures such as, in particular, the slip ratio occurring in these flowing mixtures. It will be noted that the slip ratio can be defined as the ratio between the flow rate of the gas of the gas phase and that of the liquid of the liquid phase, given a biphasic mixture flowing in a pipeline.

The flow rates of each phase are themselves defined as the ratio between the volume flow rate of each of them and the section for the passage thereof in the pipeline, also known as the hold-up section.

Known methods currently used for determining the GVF ratio of the gas volume flow rate to the volume flow rate of a multiphase hydrocarbon mixture use the following process or sequence of steps:
measuring the section occupied by the gas phase, in a relative value with respect to the total section of the pipeline;
determining the slip ratio S by physical measurement;
determining the GVF using the measured slip ratio S.

Examples of methods currently used include that described by S. JAYAWARDANE SPE, Society of Petroleum Engineers Inc. and B. C. THEUVENY, Schlumberger, presented by the authors at the 2002 Annual Technical Conference and Exhibition, San Antonio, Tex., USA from 29 Sep. to 2 Oct. 2002 and published in document SPE 77405.

The aforementioned method carrying out the steps described hereinbefore necessitates the implementation of a slip ratio model based on a mechanical model of the fluids and expressing the value of the slip ratio as a function of the ratio of the occupied section, the density of the liquid phase and the gas phase, and the viscosity of the liquid. The value of the GVF is then obtained using the inverse function representing the model and the value of the measured slip ratio S.

The aforementioned method is satisfactory. However, carrying out said method requires substantial calculating means allowing calculation of the basic parameters such as the densities of the gas and liquid, water and hydrocarbons using conditions of pressure P, volume V and temperature in the pipeline and empirical correlations (EOS).

Efficient implementation of the aforementioned correlations (EOS) also requires analyses of the composition of the flowing fluid to be taken into account, and this substantially increases the cost of the calculating means and time for carrying out the aforementioned method.

The present invention seeks to reduce, if not to eliminate, the drawbacks of prior-art methods, by simplifying the calculating means and commensurately reducing the calculation time.

In particular, the present invention seeks to carry out a method allowing the ratio of the gas volume flow rate to the volume flow rate of a multiphase hydrocarbon mixture, GVF, to be determined directly using a measurement of the ratio of the section occupied by the gas phase and a thermodynamic model.

The GVF of the multiphase fluid having been obtained by carrying out the aforementioned method, the present invention also relates to a use of this method to determine the value of the slip ratio S of a phase such as the gas phase relative to at least one reference phase such as the liquid phase.

Finally, the present invention also seeks to provide a device for analysing a multiphase hydrocarbon mixture allowing not only the method for measuring the GVF of a multiphase hydrocarbon mixture according to the invention to be carried out but also parameters crucial for the management of this multiphase fluid, such as, in particular, the flow ratio between a phase and a reference phase, the mass flow rate of at least one phase of this flowing multiphase fluid, to be determined.

The method of measuring the ratio of the gas volume flow rate to the volume flow rate of a multiphase hydrocarbon mixture, comprising at least a gas phase and a liquid phase flowing in a pipeline, according to the invention, is notable in that it consists at least in sampling the gas and the liquid, under the temperature and static pressure conditions of the pipeline, and measuring at least, in the flow of the mixture, the ratio of the relative section occupied by the gas phase to the total flow section; analysing the composition of the gas and liquid samples to determine the parameters of the composition of the mixture, such as the mass or mole fraction of the carbon compounds contained in these samples, using said composition parameters to determine the intensive properties, the local thermodynamic parameters of each phase, by a thermodynamic equilibrium simulation, these local thermodynamic parameters comprising at least the density of the liquid phase or the gas phase respectively, using said local thermodynamic parameters and the ratio of the relative section occupied by the gas phase to establish the measured density of the mixture, using an adaptive process for evaluating the calculated density of the mixture and for comparing, by successive iteration, this calculated density of the mixture with this measured density of the mixture in order to calculate the intensive properties such as the local density of the liquid phase, the gas phase and the mixture, and, if the calculated density of the mixture and the measured density of the mixture are equal, the intensive properties of the mixture being established and the mixture physically analysed and analytically reconstructed, calculating the ratio of the gas and mixture volume flow rate, expressed as the ratio of the product of the gas volume flow rate and the gas mole flow rate, to the sum of the product of the volume flow rate of the gas and the mole flow rate of the gas and the product of the volume flow rate of the liquid and the mole flow rate of the liquid.

The method according to the invention is used for managing the operation for producing hydrocarbons in real time, in particular for managing the production of wells downstream of wellheads and, more generally, for the management of the pipeline for mixing multiphase hydrocarbons.

The method according to the invention will be better understood on reading the following description and examining the following drawings, in which:

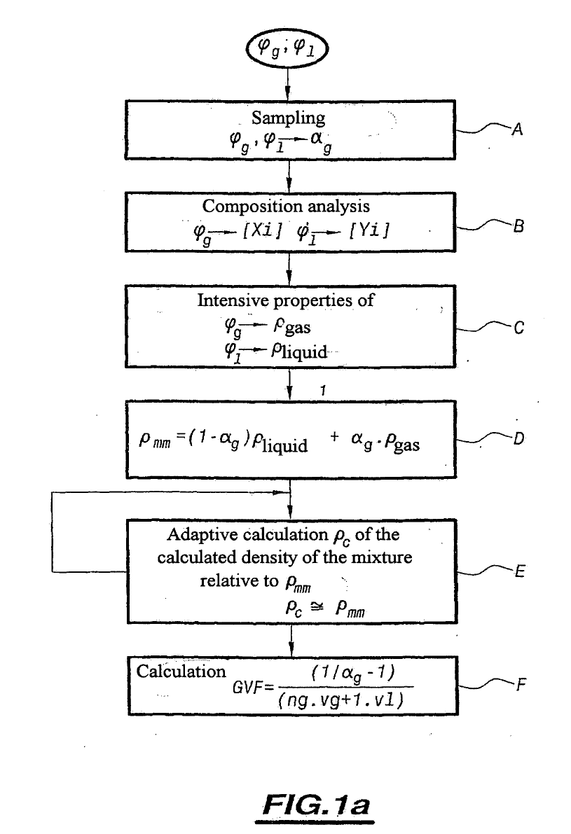

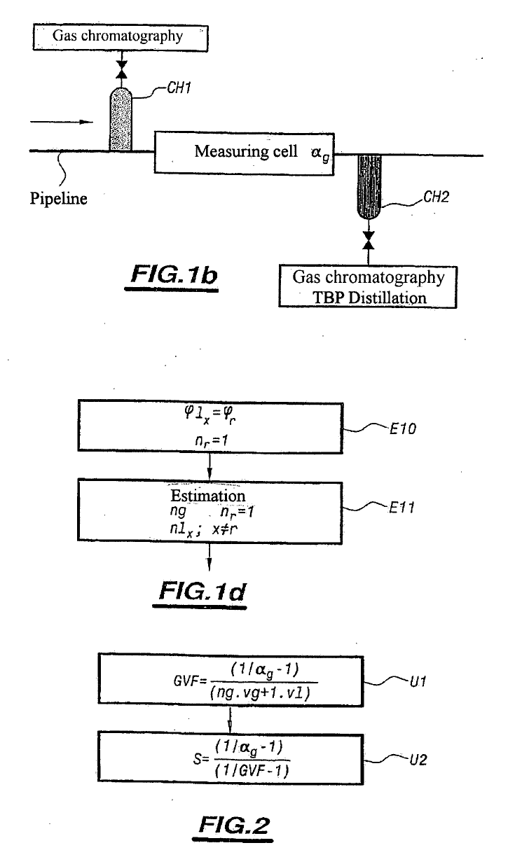

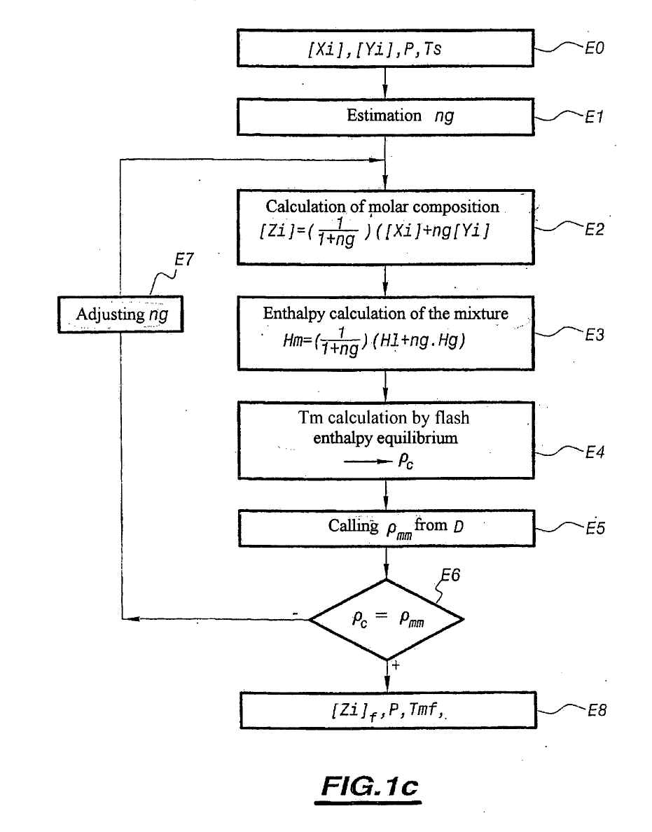

FIG. 1a is, by way of example, a general flow chart of the steps for carrying out the method according to the invention;

FIG. 1b is, purely by way of example, a specific diagram of the carrying-out of the sample step illustrated in FIG. 1a;

FIG. 1c shows, by way of example, a specific non-limiting embodiment of the step for adaptively calculating the calculated density of the mixture and for comparing this calculated density of the mixture with the measured density of this mixture obtained in step D of FIG. 1a;

FIG. 1d shows a variation of step E₁ of FIG. 1c for a liquid phase comprising water and hydrocarbons; and

FIG. 2 shows, purely by way of example, a particularly notable use of the method according to the invention, applied for determining the slide ratio of a phase of a multiphase hydrocarbon mixture, comprising at least a gas phase and a liquid phase in equilibrium.

A more detailed description of the method for measuring the ratio of the gas volume flow rate to the volume flow rate of a multiphase hydrocarbon mixture according to the subject-matter of the present invention will now be given in relation to FIG. 1a.

As illustrated in the aforementioned figure, there will be noted a multiphase hydrocarbon mixture flowing in a pipeline under normal operating conditions. This mixture is believed to comprise at least a gas phase and a liquid phase, denoted by φ_{g} and φ₁ respectively, flowing in the aforementioned pipeline.

The method according to the present invention consists, as illustrated in FIG. 1a, in sampling the gas and the liquid in a step A, under the temperature and pressure conditions of the pipeline, and in measuring, at least in the flow of the mixture, the ratio of the relative section occupied by the gas phase to the total flow section. This ratio is denoted by α_{g}.

The sampling step A is then followed by a step B consisting in analysing the composition of the gas and liquid samples in order to determine the composition parameters of the mixture such as the mass or the molar composition of the carbon compounds contained in these samples.

More specifically, it will be noted that the aforementioned mass or molar composition is denoted by [Xᵢ] for the gas phase and [Yᵢ] for the liquid phase respectively, the index i denoting reference indices of the aforementioned carbon compounds.

Generally, it will be noted that the carbon compounds are denoted by the designation thereof with reference to the number of carbon atoms, C₅-C₈ for example, or superscripts, i denoting in fact the index of the corresponding carbon compounds.

Step B is then followed by a step C consisting in determining, using the composition parameters [Xᵢ] and [Yᵢ] of the gas phase and the liquid phase respectively, the intensive properties i.e. the local thermodynamic parameters of each liquid or gas phase respectively, using the aforementioned composition parameters with the aid of a thermodynamic equilibrium simulation.

More specifically, it will be noted that the local thermodynamic parameters comprise at least the density of the liquid phase, denoted by ρ_{liquid}, and the density of the gas phase, denoted by ρ_{gas}.

Steps A, B and C then allow implementation of a step D consisting in establishing, using the local thermodynamic parameters, i.e. basically the density of the liquid phase or the gas phase, respectively, and the ratio of the relative section occupied by the gas phase, i.e. the aforementioned parameter α_{g}, the measured density of the mixture denoted by ρₘₘ, the measured density of the mixture confirming the equation:

ρₘₘ=(1−α_{g})ρ_{liquid}+α_{g}ρ_{gas}

Step D is then followed by a step E consisting in calculating, using an adaptive process, the evaluation of the calculated density of the mixture, denoted by ρ_{c}, and in comparing, by successive iteration, the calculated density of the mixture ρ_{c} with the measured density of the mixture ρₘₘ in the preceding step D, the intensive properties of the aforementioned mixture such as the local density of the liquid phase, the gas phase and the mixture.

It will be understood, in particular, that the aforementioned adaptive calculation can be carried out if the calculated density of the mixture ρ_{c} is sufficiently different from the measured density of the mixture ρₘₘ, the methods for measuring and analysing the local thermodynamic parameters not being sufficiently similar, but that, on the other hand, if the calculated density of the mixture ρ_{c} and the measured density of the mixture ρₘₘ are equal to each other, the intensive properties of the mixture are established and the mixture is then physically analysed and analytically reconstructed by carrying out the method according to the present invention.

In FIG. 1a, the adaptive nature of the calculation of the calculated density of the mixture ρ_{c}, relative to the measured density of the mixture ρₘ, is represented by the return arrow, the adaptive calculation being carried out if the calculated density of the mixture and the measured density of the mixture are not sufficiently equal.

Nevertheless, it will be noted that the notion of equality is a notion of numeric equality, i.e. a notion of equality given a threshold value inherent to the accuracy of the measurements, wherein this threshold value can be taken to be equal to within a few percent.

If equality of the calculated density of the mixture ρ_{c} and the measured density of the mixture ρₘₘ is achieved under the conditions referred to hereinbefore, step E is then followed by a step F consisting in calculating the ratio of the gas volume flow rate and the volume flow rate of the mixture, this ratio being expressed as the ratio of the product of the volume flow rate of the gas and the mole flow rate of the gas to the sum of the product of the volume flow rate of the gas and the mole flow rate of the gas and the product of the volume flow rate of the liquid and the mole flow rate of the liquid in accordance with the equation:

$$G V F = \frac{( 1 / {α}_{g} - 1 )}{( {n}_{g} \cdot {V}_{g} + 1 \cdot vl )}$$

In the above equation it will be noted that α_{g} denotes the ratio of the relative section occupied by the gas phase to the total flow section, ng denotes the gas volume flow rate, the liquid volume flow rate n1 being taken to being equal to 1, this flow rate being conventionally standardised to the unit value.

Furthermore, vg denotes the gas mole flow rate and v1 denotes the mole flow rate of the liquid.

Various observations will now be made concerning the carrying-out of steps A to F of the method according to the present invention as illustrated in FIG. 1a.

Generally, it will be noted that step A, in which the liquid phase and the gas phase are sampled, thus consists in isolating the liquid and the gas from the flowing mixture by separation, in order to derive therefrom a composition analysis.

For this purpose, as illustrated in FIG. 1b, there are placed, for example either side of a physical measuring cell for measuring the parameter of the ratio of the relative section occupied by the gas phase to the total flow section, i.e. the parameter α_{g}, two collection chambers, i.e. chambers for diffusing the gas from the gas phase or for decanting the liquid from the liquid phase respectively, these collection chambers CH₁ and CH₂ being referred to in the technical field as “boot”. They allow, in a manner known per se, the gas of the gas phase or the liquid of the liquid phase, respectively, to accumulate under the temperature and pressure conditions of the pipeline.

The taking of the aforementioned samples is justified in view of the fact that the two samples taken of liquid or gas, respectively, are characteristic of the phases present in the measuring cell. This hypothesis is justified even though, in the absolute, there are some losses in pressure or some mechanical phenomena which tend to add or remove volatile components to or from the gas or liquid. The aforementioned sampling is carried in the boots and therefore in the static state, but the sampled products are representative of the components of the flowing liquid and gas phases respectively. In this same figure TBP denotes the true boiling point of the sampled component.

However, a sensitivity analysis, such as the slip ratio of the flow, has revealed that an error in the evaluation of the composition of the intermediate compounds, typically, in particular, of the carbon compounds C₅-C₈ (an error caused by poor sampling), has little impact on the calculation of the aforementioned slip ratio.

The physical reason for this is that the concentration of these intermediate compounds is generally negligible compared to the compounds determined with a high degree of precision in the fluids or mixtures flowing in the oil product production lines.

More specifically, it will be noted that the collection chambers CH₁, CH₂ illustrated in FIG. 1b can also be replaced by means for the tapping of liquid or gas, respectively, provided in the same region on the line. In all cases, the only constraint is to avoid excessive losses in pressure which would be liable to have an impact on the intensive properties of the sampled fluids, which properties have to remain compatible of those of the measuring cell.

With reference to FIG. 1b it will be noted that the cell for measuring the ratio of the relative section occupied by the gas phase to the total flow section can consist of a cell for measuring by absorption of rays, such as γ rays for example, allowing the corresponding ratio α_{g} to be determined by differentiating the absorption carried out by the section occupied by the gas phase relative to the liquid phase and, finally, relative to the entire section of the pipeline.

With regard to the implementation of step B, in which the composition of the gas and liquid sample is analysed, it will be noted that this operation can be carried out for gas, also referred to as “light ends”, by chromatography.

An analysis extended to cover the carbon compounds C₇ to C₈ has proven ample, especially in view of the fact that the pipeline temperature rarely exceeds 90° C. to 100° C.

It will be noted that the boiling point of the carbon compound C₇ is 120° C. at atmospheric pressure and that the temperature margin prior to boiling of this product is entirely acceptable.

With regard to the carrying-out of the analysis of the composition of the liquid and, in particular, of the products such as oil, also known as “heavy ends”, this analysis can be carried out by physical distillation.

However, in order to save time and to carry out the method according to the invention substantially in real time, preference will be given to a simulated distillation, in particular, in accordance with standard IASTN 2887 proposed by the American Society for Thermodynamics, which advocates an analysis interval between the carbon compounds C₅ and C₄₄ which can prove sufficient in characterising the heavy ends.

However, it will be noted that the aforementioned high-temperature simulated distillation nowadays allows the carbon compound C₁₂₀ to be achieved but that the carrying-out thereof for carbon compounds having an index of greater than C₄₄, requires mores substantial calculating means and longer processing times.

At the end of step B, it will be noted that the composition parameters are denoted by:
[Xᵢ] for the gas phase φ_{g}
[Yᵢ] for the liquid phase φ₁, i denoting in both cases the index of the corresponding carbon compounds.

Step C can then be carried out using the aforementioned composition parameters which allow the intensive properties, i.e. the local thermodynamic parameters of each phase, to be determined with the aid of a thermodynamic equilibrium simulation.

The intensive properties of each phase are, in particular, the density ρ_{liquid} of the liquid of the liquid phase and the density ρ_{gas} of the gas phase.

More specifically, it will also be noted that the densities of the gas and the liquid can also be measured physically so as to allow, by resetting relative to the aforementioned calculated density values ρ_{liquid} and ρ_{gas} in step C, the refinement of the thermodynamic model used by a resetting method. This resetting method consists, for example, in re-introducing, using the calculated density parameters of the liquid or the gas ρ_{liquid} and ρ_{gas}, respectively, the values measured locally, i.e. in the region of the gas and liquid samples, in order to reset the calculation of the density ρ_{liquid} and ρ_{gas} using the aforementioned composition data.

The resetting process will not be described in detail, as it corresponds to physical methods known per se.

Step C can then be followed, in accordance with a particularly notable aspect of the method according to the invention, by step B, which consists in calculating, using the local thermodynamic parameters ρ_{liquid} and ρ_{gas}, the measured density of the mixture by integrating the parameter of the ratio of the relative section occupied by the gas phase to the total flow section, parameter α_{g} in accordance with the equation:

ρₘₘ=(1−α_{g})ρ_{liquid}+α_{g}·ρ_{gas}.

Step D can then be followed by step E, illustrated in FIG. 1a, this step advantageously being carried out on the basis of a unit flow rate expressed in kilomoles/hour or in lbmoles/hour to provide poundmoles/hour or any derived unit for the liquid.

Under these conditions, it is desirable to evaluate the gas flow rate, also expressed in the corresponding unit, to arrive at a convergence and at a substantial equality of the density of the measured mixture ρₘₘ obtained in step D with the density of the calculated mixture ρ_{c}.

If equality between the density of the measured mixture ρₘₘ and the density of the calculated mixture ρ_{c} is substantially achieved under the conditions mentioned hereinbefore, then the intensive properties of the mixture, i.e. the local thermodynamic parameter properties of the mixture, are established and the mixture is physically analysed and analytically reconstructed.

If the sampling of the gas and the liquid of the gas phase and the liquid phase, respectively, is sufficiently representative of the mixture flowing in the pipeline, the temperature of the mixture is substantially the same as the sampling temperature.

This confirms the hypothesis that the liquid and gas phases taken from the collection chambers are the same as those travelling in the cell for measuring the ratio of the relative section occupied by the gas phase to the overall section of flow in the pipeline.

Step E has thus allowed analytical reconstruction of the fluid, i.e. of the flowing mixture in its entirety, and this obviously validates the method for analytically reconstructing this polyphase fluid even in the presence of a slip ratio.

Knowledge of the intensive properties of the mixture, such as the mole volumes and the respective liquid and gas proportions calculated by the flash enthalpy method in step E, thus provides the ratio of the gas volume flow rate to the multiphase hydrocarbon mixture volume flow rate, known as the GVF ratio, as stated hereinbefore in the description.

A more detailed description of step E, in which the calculated density of the mixture ρ_{c} is adaptively calculated relative to the measured density of the mixture ρₘₘ, will now be provided in relation to FIG. 1c.

In order to carry out step E of FIG. 1a, there are provided the results of the analysis of the composition of the carbon compounds of the gas phase and the liquid phase respectively, denoted by [Xᵢ] and [Yᵢ] respectively, obtained in step B, the value of the pressure in the measured pipeline, and the sampling temperature T_{S} measured in the region of the chambers for collecting the gas or the liquid respectively.

All of this data forms the starting step E₀ of FIG. 1c.

The aforementioned starting step is followed, in a step E₁, by an estimation of n_{g}, denoting the gas mole flow rate brought to a unit liquid mole flow rate, as stated hereinbefore in the description.

Step E₁ is then followed by a step E₂ consisting in calculating the molar composition of the mixture in accordance with the equation:

$$[ {Z}_{i} ] = ( \frac{1}{1 + {n}_{g}} ) ( [ {X}_{i} ] + {n}_{g} [ {Y}_{i} ] ) .$$

In the above equation, it will be noted that the molar composition is thus obtained for all of the corresponding carbon compounds of index i.

Step E₂ is then followed by a step E₃ consisting in calculating the enthalpy of the mixture in accordance with the equation:

$${H}_{m} = ( \frac{1}{1 + {n}_{g}} ) ( {H}_{l} + {n}_{g} {H}_{g} ) .$$

In the above equation, it will be noted that:
Hₘ denotes the enthalpy of the mixture;
H₁ denotes the enthalpy of the liquid;
H_{g} denotes the enthalpy of the gas.

Step E₃ is then followed by a step E₄ consisting in calculating the temperature of the mixture by simulation of a flash enthalpy equilibrium using the pressure value B, the molar composition obtained in step E₂ and the enthalpy of the mixture Hₘ obtained in step E₃. This operation allows the calculated density ρ_{c} of the mixture to be calculated.

Following step E₄, calling the value of the density of the measured mixture ρₘₘ obtained in step D then allows, in step E₆, the value of the calculated density ρ_{c} to be subjected, in step E₄ to a test of equality with the measured value of the density of the mixture ρₘₘ.

The notion of equality has been defined hereinbefore in the description.

In the event of a negative response to the aforementioned test E₆, the calculated density of the mixture not being sufficiently similar to the measured density of the mixture, the step of calculating the molar composition E₂ is returned to via a step E₇ allowing the value of the estimation of n_{g} to be actually adjusted.

The process for adjusting the value of n_{g} can be carried out either using what is known as the secant mathematical method or using a more general method, the Newton-Raphson method for example. These mathematical methods are carried out by commercially available computational algorithms and programs and will therefore not be described in detail. They provide convergence based on the readjustment of the value of n_{g}, the calculated density value of the mixture ρ_{c} with the measured density value of the mixture ρₘₘ.

In the event of a positive response to the comparison test E₆, there are retained in a step E₈, for the molar composition, the values of the final molar composition [Zᵢ]_{f} calculated at the last iteration caused by the return E₇, the pressure value P and the temperature value of the final mixture T_{mf}.

The method according to the invention, as described in relation to FIGS. 1a, 1b and 1c, must be understood as a method relating to the measurement of the ratio of the gas volume flow rate to the volume flow rate of a multiphase hydrocarbon mixture.

In particular, with reference to FIG. 1a, although step D, described in conjunction with this figure, calls on an equation expressed in the case of a biphasic mixture, all of the above equations can be used for a multiphase mixture under the following conditions.

For a liquid phase comprising a mixture of water and hydrocarbons, step E₁ of FIG. 1c consisting in estimating the gas mole flow rate of the gas phase relative to the mole flow rate of the liquid of the liquid phase, can advantageously be replaced with a step consisting in fixing one of the components of the liquid, forming a reference phase φ₁ₓ=φᵣ, at a unit mole flow rate, in a step E₁₀ illustrated in FIG. 1d, then in estimating in a step E11 the relative mole flow rate of the gas or of the other component of the liquid, respectively, relative to the unit mole flow rate of the reference phase.

This provides a relative mole flow rate vector consisting of all of the relative mole flow rate components of each phase, relative to the reference phase.

1. Method of measuring the ratio of the gas volume flow rate to the volume flow rate of a multiphase hydrocarbon mixture, comprising at least a gas phase and a liquid phase flowing in a pipeline, characterised in that said method consists at least in:
a) Sampling the gas and the liquid under the temperature and pressure conditions of the pipeline, and measuring at least, in the flow of the mixture, the ratio of the relative section occupied by the gas phase to the total flow section;
b) analysing the composition of the gas and liquid samples to determine the composition parameters of the mixture, such as the mass or mole fraction of the carbon compounds contained in these samples;
c) using said composition parameters to determine the intensive properties, local thermodynamic parameters of each phase, by a thermodynamic equilibrium simulation, said local thermodynamic parameters comprising at least the density of the liquid phase or the gas phase respectively;
d) using said local thermodynamic parameters and the ratio of the relative section occupied by the gas phase to establish the measured density of the mixture;
e) using an adaptive process for evaluating the calculated density of the mixture and for comparing, by successive iteration, said calculated density of the mixture with said measured density of the mixture in order to calculate the intensive properties such as the local density of the liquid phase, the gas phase and the mixture; and, if the calculated density of the mixture and the measured density of the mixture are equal, the intensive properties of the mixture being established and the mixture physically analysed and analytically reconstructed,
f) calculating the ratio of the gas and mixture volume flow rate, expressed as the ratio of the product of the gas volume flow rate and the gas mole flow rate, to the sum of the product of the volume flow rate of the gas and the mole flow rate of the gas and the product of the volume flow rate of the liquid and the mole flow rate of the liquid.

2. Method according to claim 1, characterised in that step a) consists at least in placing, in series on said pipeline, a cell for measuring the ratio of the section occupied by the gas phase to the total section and, in the vicinity of this measuring cell, a chamber for collecting the gas or the liquid respectively, in order to sample the gas phase or the liquid phase respectively.

3. Method according to claim 1, characterised in that step b) is carried out by chromatography of the gas sample.

4. Method according to claim 1, characterised in that step b) is carried out by distillation or simulated distillation of the liquid sample.

5. Method according to claim 1, characterised in that step d) consists in calculating the measured density of the mixture using the equation:
ρₘₘ=(1−α_{g})ρ_{liquid}+α_{g}·ρ_{gas}
wherein
α_{g} denotes the ratio of the section occupied by the gas phase to the total flow section;
ρ_{liquid} denotes the density of the liquid;
ρ_{gas} denotes the density of the gas;
ρₘₘ denotes the measured density of the mixture.

6. Method according to claim 1, characterised in that said adaptive process for evaluating the calculated density of the mixture and for comparing said calculated density of the mixture with the measured density of the mixture consists at least, using the composition parameters of the mixture, the temperature of the gas and liquid samples taken from the gas and liquid phases respectively, in:
e₁) estimating the relative mole flow rate of the gas of the gas phase relative to the mole flow rate of the liquid of the liquid phase, standardised to the unit value;
e₂) calculating the molar composition of the mixture of all of the carbon compounds and the constituents contained in this mixture, using the composition parameters thereof;
e₃) calculating the enthalpy of the mixture using the enthalpy of the liquid, the enthalpy of the gas and the estimated relative mole flow rate of the gas;
e₄) simulating a thermodynamic equilibrium by a flash enthalpy calculation to determine the temperature of the mixture and the density of the mixture calculated using the static pressure of the mixture flowing in the pipeline, the molar composition of the mixture and the enthalpy of the mixture;
e₅) evaluating the measured density of the mixture using the ratio of the section occupied by the gas phase to the total flow section of the density of the liquid and the density of the gas:
e₆) subjecting the measured density of the mixture and the calculated density of the mixture to an equality test: and, in the event of a negative response to said equality test, the calculated density of the mixture having a differing value signifying the measured density of the mixture,
e₇) adjusting the estimated value of the relative mole flow rate of the gas of the gas phase and restarting, by successive iterations, steps e₂) to e₆) if the equality test e₆) is not satisfied; otherwise,
e₈) the calculated density of the mixture having a value substantially equal to the value of the measured density of the mixture, and the mixture being physically analysed and analytically reconstructed, attributing to the mixture the molar composition obtained in step e₂) carried out at the last iteration.

7. Method according to claim 6, characterised in that the step consisting in adjusting the estimated value of the relative mole flow rate of the gas is carried out using a secant method or Newton-Raphson method process.

8. Method according to claim 6, characterised in that, for a liquid phase comprising water and hydrocarbons, step e₁) consisting in estimating the mole flow rate of the gas of the gas phase relative to the mole flow rate of the liquid of the liquid phase, is replaced by a step consisting in:
fixing one of the components of the liquid, forming a reference phase, at a unit mole flow rate;
estimating the relative mole flow rate of the gas or of the other component of the liquid, respectively, relative to the unit mole flow rate of the reference phase, thus providing a relative mole flow rate vector formed by all of the relative mole flow rate components of each phase relative to the reference phase.

9. Use of the method according to claim 1 for calculating the slip ratio of a phase of a multiphase hydrocarbon mixture comprising at least a gas phase and a liquid phase sliding in a pipeline, characterised in that said use consists in:
measuring the ratio of the gas volume flow rate and a component of a liquid phase forming a reference phase, according to claim 1;
calculating said slip ratio in accordance with equation:
$$S = \frac{( \frac{1}{{α}_{g}} - 1 )}{( \frac{1}{GVF} - 1 )}$$
wherein
α_{g} denotes the ratio of the section occupied by the gas phase to the total flow section;
GVF denotes the ratio of the gas volume flow rate and a component of a liquid phase forming the reference phase;
S denotes the slip ratio.
